(19) United States
(12) Patent Application Publication
(10) Pub. No.: US 2026/0023094 A1
(43) Pub. Date: Jan. 22, 2026

(54) SENSOR UNIT

(71) Applicant: Panasonic Energy Co., Ltd., Moriguchi-shi, Osaka (JP)

(72) Inventors: Tatsuo Oshiumi, Osaka (JP); Yasuhiro Okina, Hyogo (JP); Nobuto Matoba, Osaka (JP)

(73) Assignee: Panasonic Energy Co., Ltd., Moriguchi-shi, Osaka (JP)

(21) Appl. No.: 18/996,340

(22) PCT Filed: Jul. 7, 2023
(86) PCT No.: PCT/JP2023/025331

§ 371 Date: Jan. 17, 2025

(30) Foreign Application Priority Data
Jul. 28, 2022 (JP) 2022-120938

(51) Int. Cl. G01P 1/02

(52) U.S. Cl. CPC G01P 1/02

(57) ABSTRACT

A sensor unit (10) is loaded into battery production equipment and comprises a bottomed cylindrical case (11) that is processed similarly to a battery outer can by the battery production equipment, and a sensor that detects a force acting on the case from the battery production equipment. The sensor unit further comprises a first component (20) to which the sensor is attached and which is accommodated inside the case, and at least one second component (50) made of resin, the second component (50) being disposed so as to engage with the outside of the first component. The second component comprises an elastic part that is elastically pressed against the inner circumferential surface of the case, and a hollow section formed inside of the elastic part.

TECHNICAL FIELD

The present disclosure relates to a sensor unit to be introduced to a battery manufacturing facility.

### BACKGROUND ART

Batteries such as lithium ion batteries have a structure, for example, in which an electrode assembly and an electrolyte are housed in a bottomed cylindrical exterior housing can and an opening of the exterior housing can is sealed by a sealing assembly. Batteries having such a structure are manufactured in general through a large number of manufacturing processes. In the manufacturing processes of the battery, after the electrode assembly is housed in the exterior housing can, for example, groove-forming, lead welding, crimping, and the like are performed. For this purpose, the exterior housing can in which the electrode assembly is housed is transported to a plurality of apparatuses which constitutes a manufacturing facility, and predetermined processing is performed in each apparatus.

Since a state of the battery manufacturing facility affects yield, quality, productivity, and the like of the batteries, it is necessary to maintain a superior state through periodic inspections. However, since the battery manufacturing facility is composed of a large number of processing apparatuses, transporting apparatuses, and the like, specifying an abnormal location is not easy, and the workload of the inspection is large.

Patent Literature 1 discloses a sensor unit to be introduced to a battery manufacturing facility, the sensor unit including a bottomed cylindrical casing that is processed in a manner similar to that of an exterior housing can of a battery by the battery manufacturing facility, and a sensor that is attached to the casing and that detects a force acting on the casing from the battery manufacturing facility. According to this sensor unit, it may be possible to visualize a force exerted on the exterior housing can from the battery manufacturing facility and to accurately and quickly specify the abnormal location in the facility.

### CITATION LIST

### Patent Literature

PATENT LITERATURE 1: International Publication No. WO 2022/080209

### SUMMARY

In the sensor unit disclosed in Patent Literature 1, an O ring made of rubber is fitted into a groove in a core component to hold, in the casing, the core component to which the sensor is attached, and the O ring presses an inner circumferential surface of the casing so as to constrain a positional deviation or rotation of the core component in the casing. However, when the core component into which the O ring is fitted is inserted into the casing, friction between the O ring and the casing and friction between the O ring and the core component cause pinching of the O ring in a gap between the casing and the core component, which may result in eccentricity of the core component in the casing. In addition, there is possibility that the core component cannot be securely fixed to the inside of the casing. As a result, the detection accuracy of the sensor may be decreased.

A sensor unit according to the present disclosure is a sensor unit to be introduced to a battery manufacturing facility, the sensor unit comprising a bottomed cylindrical casing that is processed in a manner similar to a manner of an exterior housing can of a battery by the battery manufacturing facility, a sensor that detects a force acting on the casing from the battery manufacturing facility, a pillar-shaped first component to which the sensor is attached and that is housed inside the casing, and at least one second component made of a resin that is placed at an outer side of the first component to engage with the first component, wherein the second component includes an elastic portion that is elastically pressed against the inner circumferential surface of the casing and a cavity portion that is formed inside the elastic portion.

According to the sensor unit according to the present disclosure, it may be possible to visualize a force exerted on an exterior housing can from the battery manufacturing facility and to accurately and quickly specify the abnormal location in the facility.

Therefore, for example, the workload of the facility inspection can be reduced, and the yield, the quality, the productivity, and the like of the batteries can be improved. Furthermore, the first component that is a sensor attachment component can be held in the casing by the second components made of a resin that engage with the outer side of the first component and that include the elastic portions elastically pressed against the inner circumferential surface of the casing. Therefore, it is possible to prevent the eccentricity of the first component in the casing as in the case of using the O ring and to securely fix the first component in the casing, when the first component and the second components are inserted into the casing. This can further improve the detection accuracy of the sensor.

### BRIEF DESCRIPTION OF DRAWINGS

FIG. 1 is a perspective view of a sensor unit, which is an example of embodiments, when viewed from a first cover side.

FIG. 2 is a perspective view of a sensor unit, which is an example of embodiments, when viewed from a second cover side.

FIG. 3 is a diagram illustrating a relationship between a maximum outer diameter of a core component including a first component and a second component and an inner diameter of a casing before the core component is inserted into the casing.

FIG. 4 is a perspective view of a sensor unit, which is an example of embodiments, when viewed from a first cover side in a state in which the core component is taken out from the casing.

FIG. 5 is an exploded perspective view of a sensor unit, which is an example of embodiments.

FIG. 6 is a perspective view of the first component illustrated in FIG. 5, when viewed from a top side before the sensor is attached.

FIG. 7 is a perspective view of the first component illustrated in FIG. 5, when viewed from a bottom side before the sensor is attached.

FIG. 8 is an enlarged perspective view of two second components illustrated in FIG. 5.

FIG. 9 is an enlarged perspective view of the second component, when viewed from the top side.

FIG. 10 is a top view of the second component.

FIG. 11 is a perspective view of the second component taken along line A-A in FIG. 9.

FIG. 12 is a perspective view of the second component taken along line B-B in FIG. 10.

FIG. 13 is a diagram illustrating a state in which the first component is in the process of being taken out from the casing on which a grooved portion is formed.

FIG. 14 is a diagram of a comparative example illustrating a state in which a core component to which an O ring is attached is in the process of being inserted into a casing.

### DESCRIPTION OF EMBODIMENTS

Hereinafter, an example of embodiments of a sensor unit according to the present disclosure will be described in detail with reference to the drawings. Selective combination of a plurality of embodiments and variants described below is contemplated from the beginning.

In the following, a sensor unit 10 comprising a casing 11 which is identical to a bottomed cylindrical exterior housing can used in a cylindrical battery will be exemplified as an example of embodiments of the sensor unit according to the present disclosure, but the shape of the sensor unit may be suitably changed according to the battery manufacturing facility. For example, the shape of the casing of the sensor unit to be introduced to a manufacturing facility of prismatic batteries may be a bottomed prismatic shape similar to that of the exterior housing can of the prismatic battery. That is, it is sufficient that the shape of the casing of the sensor unit is a bottomed cylindrical shape.

For the casing 11 of the present embodiment, the same structure as the exterior housing can of the battery manufactured by the battery manufacturing facility is used, but alternatively, the casing 11 may be a dedicated product for the sensor unit which is different from the exterior housing can of the battery. It is sufficient that the casing of the sensor unit is substantially the same as the exterior housing can of the battery, and the shape or the like may be slightly different within a range which does not adversely affect the advantage of the present disclosure.

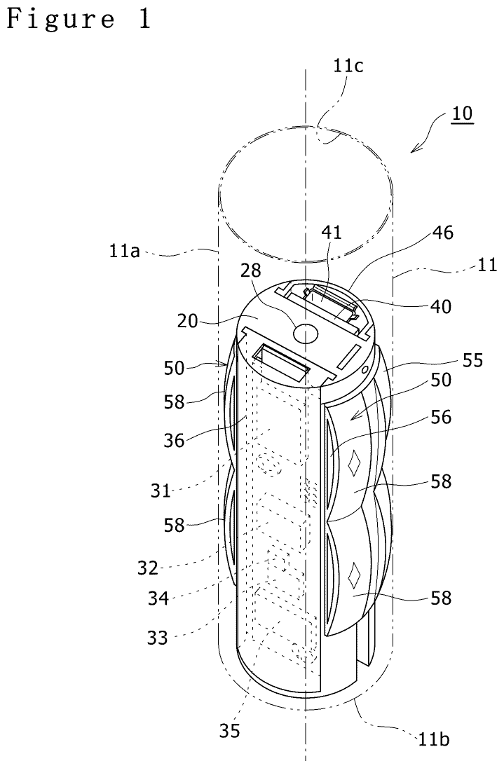

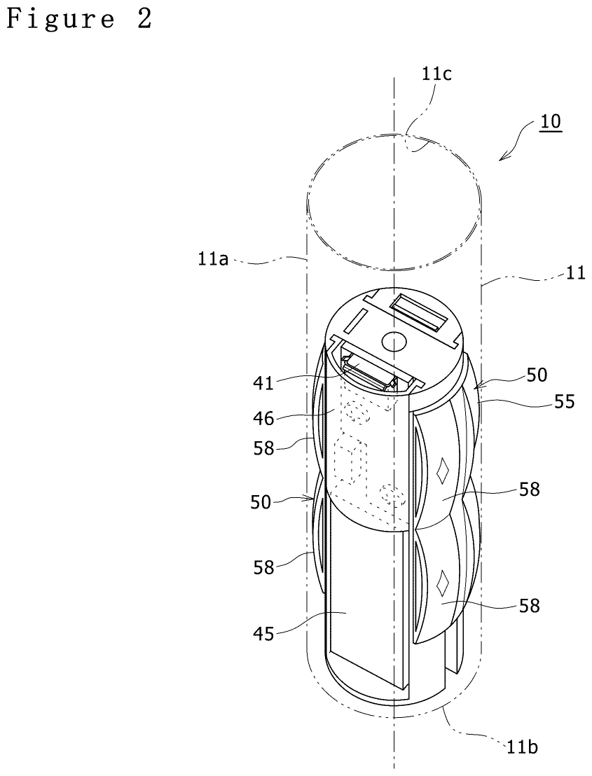

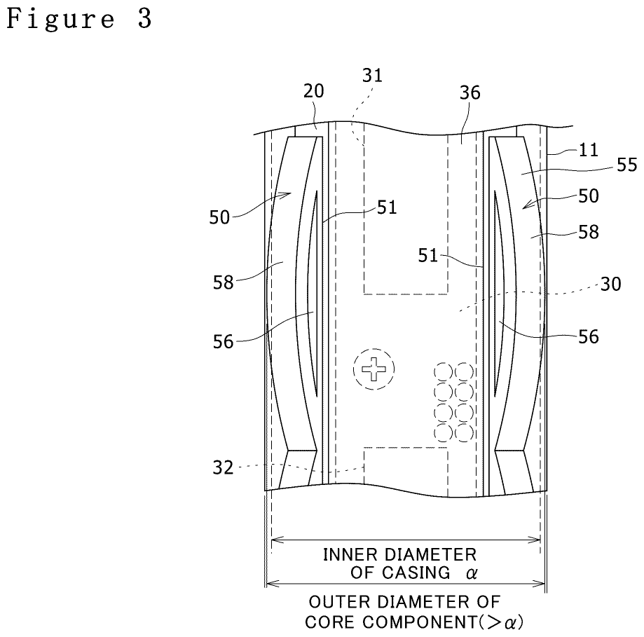

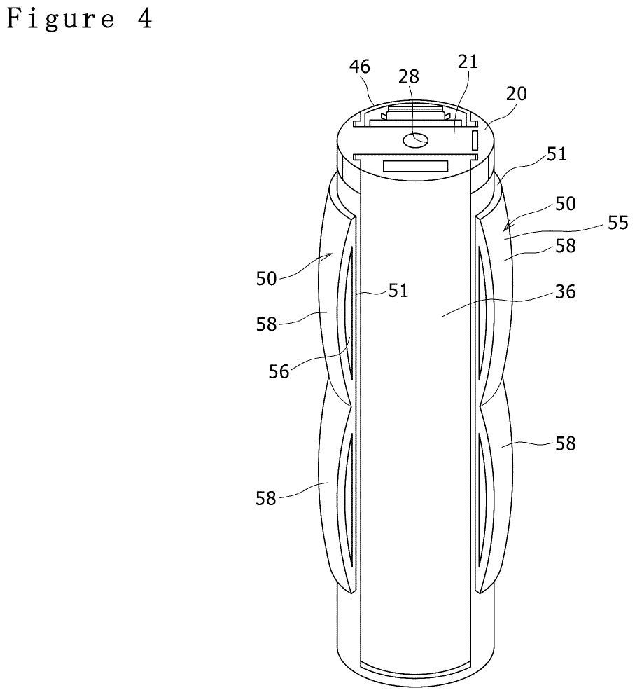

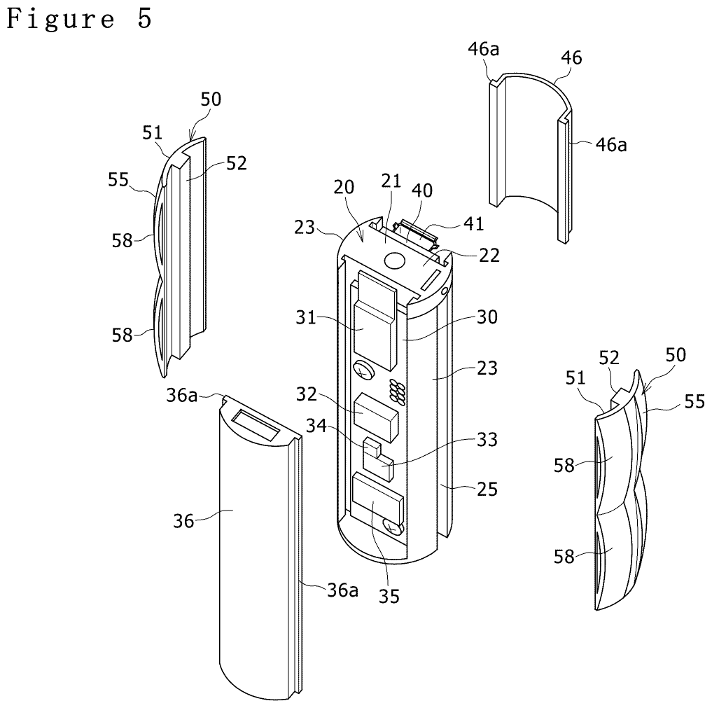

FIGS. 1 and 2 are a perspective view of the sensor unit 10 when viewed from a first cover 36 side and a perspective view of the sensor unit 10 when viewed from a second cover 46 side, respectively. FIG. 3 is a diagram illustrating a relationship between a maximum outer diameter of a core component including a first component 20 and a second component 50 and an inner diameter of the casing 11 before the core component is inserted into the casing. FIG. 4 is a perspective view of the sensor unit 10, when viewed from the first cover 36 side, in a state in which the core component is taken out from the casing 11. FIG. 5 is an exploded perspective view of the sensor unit.

As illustrated in FIGS. 1 to 3, the sensor unit 10 comprises the bottomed cylindrical casing 11, a sensor, the first component 20 to which the sensor is attached, and a second component 50 made of a resin. As will be described later in detail, the sensor unit 10 is introduced to the battery manufacturing facility in order to acquire information detected by the sensor (hereinafter, also referred to as “detection information”) to inspect a state of the battery manufacturing facility.

The casing 11 is a metal casing having a cylindrical side surface portion 11a, and a bottom surface portion 11b having a perfect circular shape in the bottom view. In FIGS. 1 and 2, the casing 11 is indicated by two-dot chain lines. The casing 11 has a bottomed cylindrical shape in which one end portion in an axial direction of the side surface portion 11a is blocked by the bottom surface portion 11b, and an opening 11c is formed at the other end portion in the axial direction of the side surface portion 11a. In the following, for the purpose of convenience of description, a direction along an axial direction perpendicular to the bottom surface portion 11b will be referred to as an “up-and-down direction,” the side of the opening 11c will be referred to as an “up side”, and the side of the bottom surface portion 11b will be referred to as a “lower side”.

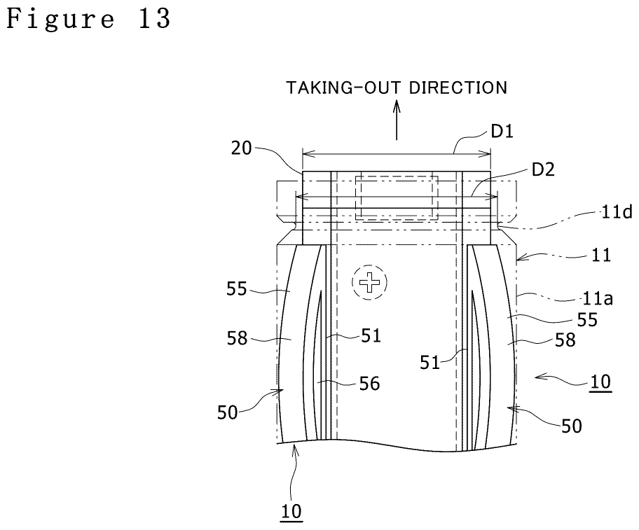

The sensor unit 10 is transported to the processing apparatuses and the like that make up the battery manufacturing facility in a manner similar to that of the product-in-process of the battery, and the casing 11 is processed by the battery manufacturing facility in a manner similar to that of the exterior housing can of the battery. In the present embodiment, a grooved portion 11d (see FIG. 13 to be described later) is formed on the casing 11 in a manner similar to that of the exterior housing can of the battery. As described above, for the casing 11, the same structure as the exterior housing can of the battery is used. The use of the same structure as the exterior housing can of the battery for the casing 11 makes it easy to apply, to the casing 11, processes similar to those of the exterior housing can. Furthermore, it becomes possible to more accurately detect the force experienced by the sensor unit 10 from the battery manufacturing facility and to more easily specify an abnormal location in the facility.

The sensor unit 10 comprises, as sensors to be attached to the casing 11 via the first component 20, an acceleration sensor 32, a gyro sensor 33, and an environment sensor 34. The acceleration sensor 32 and the gyro sensor 33 detect a force acting on the casing 11 from the battery manufacturing facility. The environment sensor 34 detects at least one of temperature, humidity and atmospheric pressure in the battery manufacturing facility. In the sensor unit 10, these sensors are housed inside the casing 11. This configuration makes it easy to process the casing 11 in a manner similar to that of the exterior housing can of the battery, and makes it possible to prevent dropping, damaging, or the like of the sensors.

When the sensor unit 10 is introduced to the battery manufacturing facility, the mounted sensors detect various information of the manufacturing facility. In an inspection method of the present embodiment, the state of the battery manufacturing facility is analyzed from the detection information detected by the sensors, and the abnormal location in the facility is specified. When there is an abnormal location in the manufacturing facility, for example, in the sensor unit 10, at the abnormal location, a force acts on the casing 11, the force being different from that in the case of no abnormality. According to this sensor unit 10, it is possible to visualize a force exerted on the exterior housing can of the battery from the battery manufacturing facility. Comparing the detection information detected by the sensors with the detection information in the case of no abnormality in the manufacturing facility makes it possible to accurately specify the abnormal location in the facility.

The acceleration sensor 32 is a device for measuring an acceleration which is an amount of change of velocity per unit time of the sensor unit 10 (casing 11). The acceleration sensor 32 generates, for example, a detection signal according to a magnitude of the acceleration in a predetermined one-axis direction or three-axis direction. When an impact is exerted on the casing 11 during transport or the like, the acceleration sensor 32 detects the impact as the acceleration. When there is an abnormal location in the battery manufacturing facility, an impact different from that in the normal case without the abnormality is exerted on the casing 11. Since the abnormality of the acceleration different from the normal case can be determined based on the detection information detected by the acceleration sensor 32, the abnormal location in the facility can be accurately specified.

The gyro sensor 33 is a device for measuring a velocity of rotational motion of the sensor unit 10 around a reference axis, and is also generally referred to as an angular velocity sensor. The gyro sensor 33 measures, for example, an angular velocity which is a rotational angle per unit time, and generates a detection signal according to the angular velocity. In the battery manufacturing facility, for example, the casing 11 is rotated when the casing is processed, and during such a process, the gyro sensor 33 measures the angular velocity of the sensor unit 10. When the gyro sensor 33 detects the angular velocity different from the normal case without the abnormality in the facility, the location at which the angular velocity is detected can be specified as the abnormal location.

The environment sensor 34 includes, for example, at least one of a thermometer, a hygrometer, and a barometer. In the battery manufacturing facility, for example, heat generation may be expected due to failure or the like. Since it is conceivable that the environment in the battery manufacturing facility such as the temperature affects the quality of the battery, the environment sensor 34 is preferably mounted on the sensor unit 10 to be able to specify an environmental abnormality in the facility. The thermometer, the hygrometer, and the barometer may be integrated, or may be separately provided.

The sensors to be attached to the casing 11 are not limited to the acceleration sensor 32, the gyro sensor 33, and the environment sensor 34, and any sensor which can detect the abnormality in the battery manufacturing facility. Other examples of the sensor include a vacuum pressure sensor and an image sensor.

The first component 20 to which the sensors are attached is housed inside the casing 11 along with the second component 50. Two second components 50 are attached to the first component 20 in a manner to sandwich the first component 20 in the radial direction. In the following, a structure in which the second components 50 are assembled to the first component 20 and the first component 20 and the second components 50 are thus integrated will be referred to as a “core component”. As will be described later in detail, the first component 20 is configured to be separated from the second components 50 to be able to be taken out from the opening 11c of the casing 11. Each second component 50 contacts an inner circumferential surface of the casing 11, so as to constrain a positional deviation, rotation, or the like of the core component during processing and transport of the sensor unit 10.

Hereinafter, the first component 20 and the second components 50 that form the sensor unit 10 will be described in detail with appropriate reference to FIGS. 1 and 5.

### First Component 20

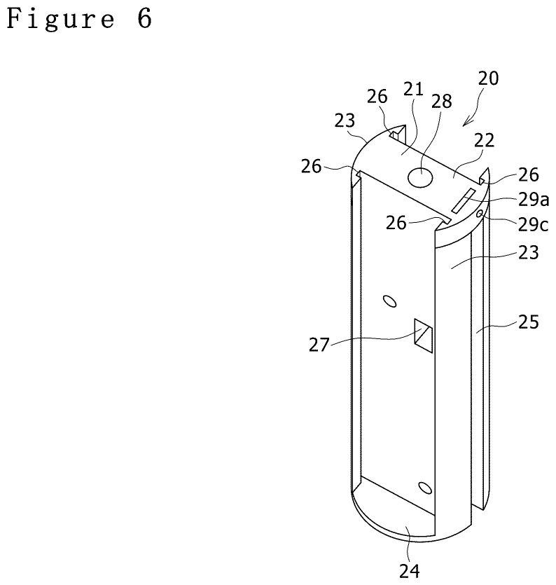

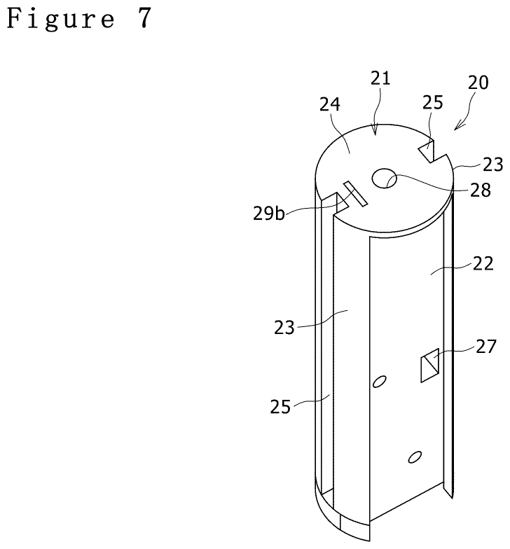

FIGS. 6 and 7 are a perspective view of the first component illustrated in FIG. 5, when viewed from a top side before the sensor is attached, and a perspective view of the first component, when viewed from a bottom side before the sensor is attached, respectively. As illustrated in FIGS. 1 to 7, the first component 20 comprises a support assembly 21 made of a resin, a first substrate 30 (FIG. 5) on which the sensors are provided, and a second substrate 40 on which a connection terminal 41 is provided. In the present embodiment, the first substrate 30 and the second substrate 40 are fixed to the support assembly 21. On the first substrate 30, the acceleration sensor 32, the gyro sensor 33, and the environment sensor 34 are mounted as sensors. In addition, on the first substrate 30, a microcomputer module 31 which functions as a wireless communication module and a microcomputer is mounted. The first component 20 further comprises the first cover 36 that covers the first substrate 30 and the second cover 46 that covers the second substrate 40.

The support assembly 21 is formed in a pillar shape elongated in the up-and-down direction. The first substrate 30 and the second substrate 40 are fixed to the support assembly 21, for example, using a screw 37. The two second components 50, the first cover 36, and the second cover 46 are attached to the support assembly 21. The first component 20 has a circular pillar shape as a whole in a state in which the two covers are attached, and has a smaller diameter than an inner diameter of the grooved portion 11d of the casing 11. This configuration enables the first component 20 to be taken out from the casing 11 to be retrieved after the grooved portion 11d is formed.

The support assembly 21 has, for example, a base 22, side surface portions 23, and a bottom surface portion 24. The bottom surface portion 24 is formed in an approximate circular shape in the bottom view. The base 22 stands on the bottom surface portion 24, and is formed in a plate shape along a radial direction of the bottom surface portion 24. The base 22 has a first surface and a second surface that are approximately flat surfaces elongated in the up-and-down direction and that are parallel with each other. The first substrate 30 is fixed to the first surface with a screw, and the second substrate 40 is fixed to the second surface with a screw.

The side surface portions 23 stand on a part of a peripheral portion of the bottom surface portion 24 and extend in the up-and-down direction, and each have an outer surface formed in an arcuate shape in cross section. The outer surfaces of the side surface portions 23 curve along the inner circumferential surface of the casing 11 and are formed on respective end portions of the base 22 to be arranged in the radial direction of the casing 11. The side surface portions 23 are portions to which the respective second components 50 to be described later are attached. In addition, the first cover 36 and the second cover 46 are attached to the support assembly 21 by being engaged with the side surface portions 23. The two covers are formed from, for example, a transparent resin, and are curved in a manner similar to that of the side surface portions 23.

A guide groove 25 extending in the axial direction is formed on the outer surface of the side surface portion 23 so that an engagement protruding portion 52 to be described later of the second component 50 is fitted into the guide groove 25. The guide groove 25 is formed across the side surface portion 23 from a lower end toward a region near an upper end along the up-and-down direction. While the upper end of the guide groove 25 is closed, the lower end is open. Therefore, in a state in which the engagement protruding portion 52 of the second component 50 is inserted into the guide groove 25 and the first component 20 and the second component 50 are thus engaged with each other, the first component 20 can be slid upward along the guide groove 25 and separated from the second component 50, as illustrated in FIG. 13 to be described later.

Guide grooves 26 (FIG. 6) into which respective protruding portions 36a and 46a of the first cover 36 and the second cover 46 are inserted are formed on an inner surface of the side surface portion 23. The guide grooves 26 are formed at four locations in total corresponding to respective end portions of the first surface and the second surface of the base 22 along the up-and-down direction from the upper ends of the side surface portions 23. In the first component 20, the side surface portion 23, the first cover 36, the side surface portion 23, and the second cover 46 are placed in this order in a circumferential direction, and the first component 20 thus has a circular pillar shape as a whole, as described above. The outer surfaces of the two side surface portions 23 and the outer surfaces of the two covers have substantially the same radius of curvature, and these outer surfaces are flush with each other.

A transverse through holes 27 (see FIGS. 6 and 7) that passes through the base 22 in a thickness direction and that is open between the first surface and the second surface is formed in the base 22. The wiring for electrically connecting the first substrate 30 and the second substrate 40 is passed through the transverse through hole 27, for example. The wiring that has passed through the transverse through hole 27 electrically connects the first substrate 30 and the second substrate 40. This makes it possible to retrieve the detection information detected by the sensors mounted on the first substrate 30 to the outside of the second components 50 through a cable connected to the connection terminal 41, for example. In addition, a predetermined signal may be also transmitted from the outside to a component such as the microcomputer module 31 mounted on the first substrate 30 via the cable.

A longitudinal through hole 28 that passes through the base 22 in the up-and-down direction is formed in the base 22. The longitudinal through hole 28 is a hole into which a bolt (not illustrated) that is used when the first component 20 is taken out from the casing 11 is inserted, and a thread groove for securing the bolt is formed in an upper portion of the longitudinal through hole 28. The longitudinal through hole 28 is formed at a position that does not intersect the transverse through hole 27, and is preferably formed at a center portion of the first component 20. When the longitudinal through hole 28 only functions as an insertion hole of the bolt, the longitudinal through hole 28 may be open in the top surface of the base 22, and may be formed only in the upper portion of the base 22.

The longitudinal through hole 28 enables insertion of a welding jig. In a wound type electrode assembly included in a cylindrical battery, a hole similar to the longitudinal through hole 28 is formed at the center portion, and, in the cylindrical battery, the welding jig is inserted into this hole and a negative electrode lead is welded to an inner surface of the bottom of the exterior housing can. Forming the longitudinal through hole 28 that has passed through the first component 20 in the up-and-down direction makes it possible to perform welding similar to the welding of the negative electrode lead and the exterior housing can using a metal piece (not illustrated) imitating the negative electrode lead, also in the sensor unit 10. The through hole 28 has a diameter that enables insertion of the welding jig.

A lead fixation portion 29a (FIG. 6) is formed on the top surface of the base 22. The lead fixation portion 29a is a portion where a metal piece (not illustrated) imitating a positive electrode lead extending from the electrode assembly of the battery, is inserted. The lead fixation portion 29a is formed in an elongated slit shape at one end portion of the top surface of the base 22. A thread hole 29c (see FIG. 6) in communication with the lead fixation portion 29a may be formed on the side surface portion 23. In this case, the metal piece inserted into the lead fixation portion 29a can be fixed by inserting a screw from the thread hole 29c. This configuration makes it possible to perform welding similar to the welding of the positive electrode lead and a sealing assembly, also in the sensor unit 10.

A memory 35 is mounted on the first substrate 30. For the memory 35, a nonvolatile memory such as a flash memory is used. The detection signal generated by the sensor is transmitted, for example, to the microcomputer module 31, a predetermined process is applied at the microcomputer module 31, and the processed signal is stored in the memory 35. The detection information detected by the sensor stored in the memory 35 is retrieved to the outside via the microcomputer module 31.

The microcomputer module 31 comprises, for example, a processor that executes a predetermined calculation process, a memory that stores a control program or the like, an input/output port, and the like. The processor is composed of, for example, a CPU, and reads out and executes the control program installed in the memory. The microcomputer module 31 sets a state in which measurement by the sensor is possible, for example, when receiving a startup signal from an external apparatus.

The microcomputer module 31 has a wireless communication module built therein. In this configuration, with the wireless communication function of the microcomputer module 31, the detection information detected by the sensor stored in the memory 35 can be transmitted to a predetermined external apparatus. No particular limitation is imposed on the communication scheme of the wireless communication module, and alternatively, the wireless communication module may be provided separately from the microcomputer.

The first component 20 comprises a battery 45 (FIG. 2) for supplying electric power to the microcomputer module 31, the sensors, the memory 35, and the like. The battery 45 has a flat plate-shaped appearance, and is provided on the second surface of the base 22. On the second surface of the base 22, the second substrate 40 is attached at the upper portion, and the battery 45 is attached at the lower portion. The battery 45 may be joined to the second surface using an adhesive tape or the like, or may be screwed on the second surface. The battery 45 includes, for example, a secondary battery, and can be charged by electric power supplied via the above-described cable.

A lead fixation portion 29b is formed on the bottom surface portion 24 of the first component 20. The lead fixation portion 29b is a hole of an elongated slit shape into which the metal piece imitating the lead is inserted, in a manner similar to that of the lead fixation portion 29a. The metal piece fixed to the lead fixation portion 29b, for example, imitates the negative electrode lead, and is welded to the inner surface of the bottom surface portion 11b of the casing 11 using the welding jig to be inserted into the longitudinal through hole 28. Alternatively, a hole for allowing passage of a screw for fixing the metal piece inserted to the lead fixation portion 29b may be formed on a bottom surface of the guide groove 25 of the side surface portion 23.

### Second Component 50

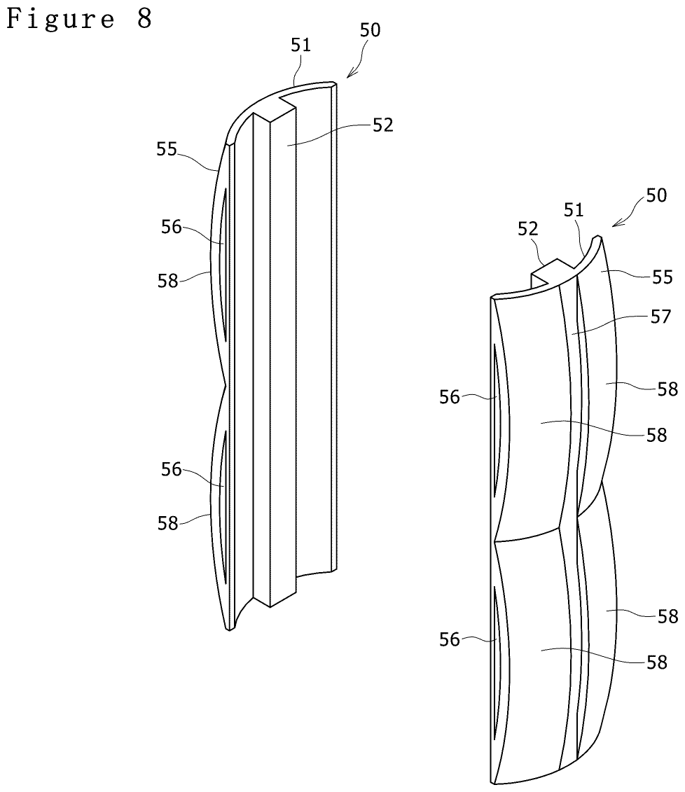

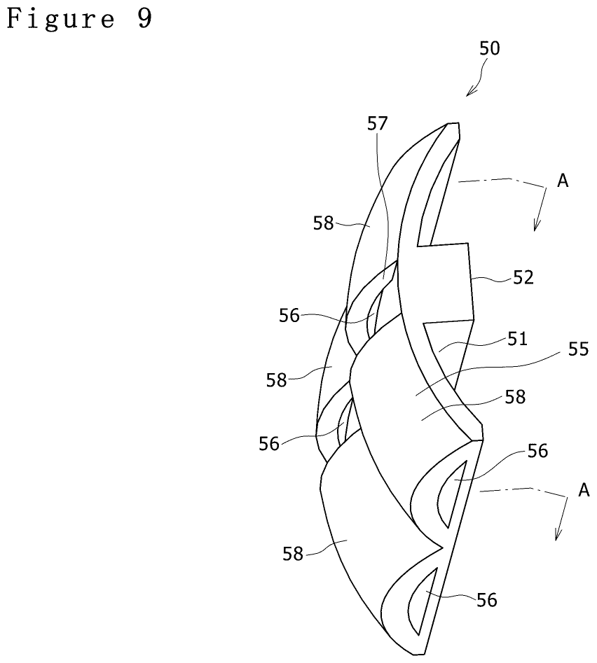

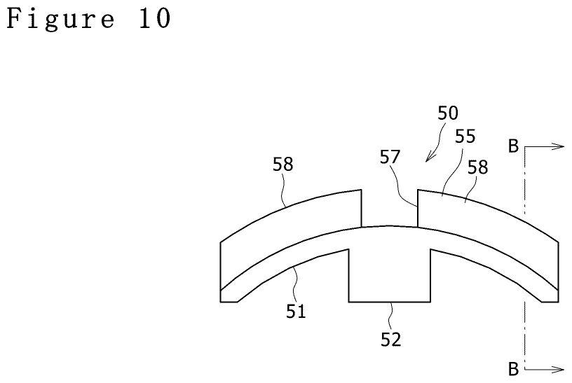

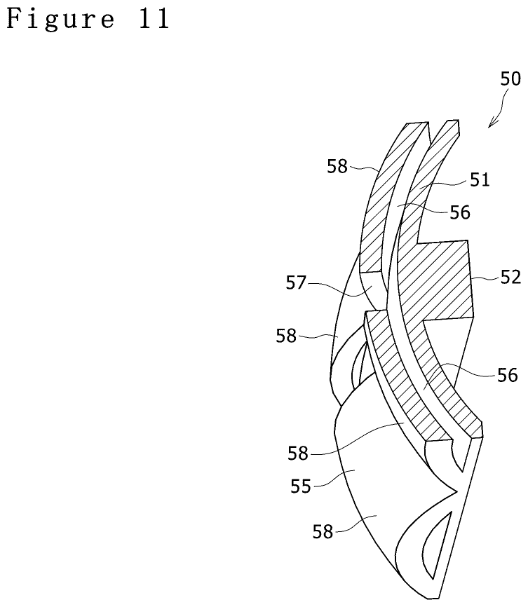

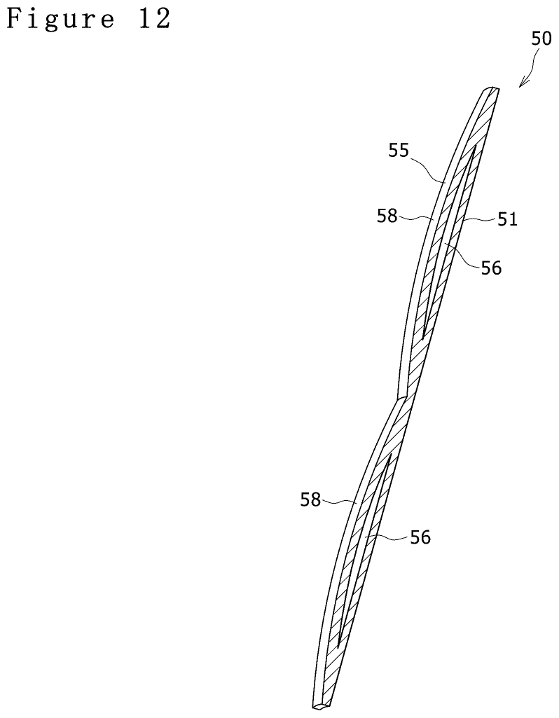

The second component 50 will be described with reference to FIGS. 8 to 12. FIG. 8 is an enlarged perspective view of the second components 50 illustrated in FIG. 5. FIG. 9 is an enlarged perspective view of the second component 50, when viewed from the top side. FIG. 10 is a top view of the second component 50. FIGS. 11 and 12 are a perspective view of the second component 50 taken along line A-A in FIG. 9, and a perspective view of the second component taken along line B-B in FIG. 10, respectively.

The second components 50 are two components made of a resin that are placed at an outer side of the first component 20 to engage with the first component 20, as described above. The two second components 50 have the same shape and dimension with each other. More specifically, the two second components 50 are attached to the first component 20 in a manner to sandwich the first component 20 in the radial direction. Each of the two second components 50 includes an inner wall 51 facing an outer circumferential surface of the first component 20, and an outer wall 55 facing an inner circumferential surface of the casing 11. Both ends of the outer wall 55 in the axial direction are connected to the inner wall 51. Furthermore, each of the two second components 50 includes, in the cross section along the axial direction, elastic portions 58 formed to project in an arcuate manner toward the casing 11, and cavity portions 56 formed inside of the respective elastic portions 58.

The inner wall 51 is a thin plate portion having an arcuate shape in cross section along an arcuate portion in cross section of the outer surface of the side surface portion 23 (FIG. 6) of the first component 20. The inner wall 51 has a shape with a certain width in the circumferential direction and elongated in the up-and-down direction. An inner circumferential side surface of the inner wall 51 has substantially the same curvatures as the arcuate portion in cross section of the outer surface of the side surface portion 23 of the first component 20. A length in the up-and-down direction of the second component 50 is shorter than a length in the up-and-down direction of the first component 20.

The engagement protruding portion 52 having a rectangular shape in cross section and extending in the axial direction is formed at a center in the circumferential direction of the inner circumferential side surface of the inner wall 51. The engagement protruding portion 52 is formed over the entire length in the axial direction of the inner wall 51. The engagement protruding portion 52 is configured to engage with the guide groove 25 formed on the side surface portion 23 of the first component 20 and to be slidable in the axial direction. Most of the outer surface of the side surface portion 23 is covered by the second component 50 in a state in which the engagement protruding portion 52 engages with the guide groove 25.

When the two second components 50 are attached to the first component 20 to form the core component, the maximum outer diameter of the core component is an outer diameter at a top position that protrudes to outermost sides of the elastic portions 58 of the two second components 50. FIG. 3 is a diagram illustrating a relationship between a maximum outer diameter of the core component (core component in a free state) and an inner diameter of the casing 11 before the core component is inserted into the casing 11. As illustrated in FIG. 3, the maximum outer diameter of the core component in a free state is preferably greater than the inner diameter of the cylindrical side surface portion 11a of the casing 11. When the inner diameter of the side surface portion 11a of the casing 11 is α mm, the maximum outer diameter of the core component in a free state is greater than α mm, and more specifically, is preferably greater than or equal to (α×1.002) mm and less than or equal to (α×1.008) mm. More preferably, the maximum outer diameter of the core component in a free state is greater than or equal to (α×1.004) mm and less than or equal to (α×1.006) mm. In this way, in the core component inserted in the casing 11, the elastic portions 58 of the second components 50 are elastically pressed against the inner circumferential surface of the casing 11.

In the second component 50, the two elastic portions 58 adjacent to each other in the circumferential direction are separated by the groove portion 57 formed at a center in the circumferential direction of the outer circumferential side wall over the entire length in a substantial axial direction. Each elastic portion 58 is thus pressed against the inner circumferential surface of the casing 11, thereby making it easier to cause elastic deformation of each elastic portion 58.

Forming the cavity portion 56 inside of the elastic portion 58 as described above enables the elastic portion 58 to be greatly elastically deformed in the radial direction. This enables the elastic portion 58 to exert a great elastic force on the inner circumferential surface of the casing 11. In the core component in a free state, connecting both ends in the axial direction of the outer wall 55 to the inner wall 51 enables the elastic portion 58 to stably maintain the shape protruding outward in an arcuate shape in cross section. This enables the elastic portion 58 to more stably exert an elastic force on the inner circumferential surface of the casing 11.

The second component 50 can be manufactured by, for example, a 3D printer. Therefore, as a resin forming the second component 50, a material suitable when a product is formed by a 3D printer such as an acrylic-based resin, a urethane-based resin or a material obtained by blending urethane in an acrylic-based resin, for example, AR-M2 (product name) made by KEYENCE CORPORATION, can be used.

As described above, in the guide groove 25, the upper end is blocked and the lower end is open. The first component 20 is configured to be slid toward one side (upper side) in the axial direction along the guide grooves 25 with which the respective engagement protruding portions 52 of the second components 50 are engaged to be able to be separated from the second components 50. The first component 20 is configured to be separated from the second components 50 to be able to be taken out from the opening 11c of the casing 11.

In a state in which the core component is housed in the casing 11 and the outer walls 55 of each second component 50 is pressed against the inner circumferential surface of the casing 11, a strong frictional force is generated between the casing 11 and the second components 50 by the elastic forces of the second components 50. This securely constrains a positional deviation, rotation, or the like in the up-and-down direction of the core component.

FIG. 13 illustrates a state in which the first component 20 is in the process of being taken out from the casing 11 on which the grooved portion 11d is formed. In the embodiment, the grooved portion 11d is formed near the opening 11c in the casing 11, and the first component 20 can be separated from the second components 50 and taken out from the opening 11c of the casing 11 even after formation of the grooved portion 11d. In the cylindrical battery, the grooved portion for supporting the sealing assembly is generally formed on the upper portion of the exterior housing can. In the embodiment, the grooved portion 11d is formed in the casing 11 by the battery manufacturing facility in a manner similar to that of the exterior housing can.

The grooved portion 11d is formed in an annular shape along the circumferential direction near the opening 11c of the side surface portion 11a. The sensor unit 10 is rotated with a high speed by a groove-forming apparatus, and a processing jig is pressed against the outer circumferential surface of the side surface portion 11a. In this manner, the grooved portion 11d having a recessed outer circumferential surface and an expanded inner circumferential surface is formed.

At an inside of the casing 11 on which the grooved portion 11d is formed, the first component 20 is placed in such a manner as to not overlap with the grooved portion 11d in the axial direction (up-and-down direction) of the casing 11, and the second components 50 are placed in such a manner as to overlap with the grooved portion 11d in the axial direction. As illustrated in FIG. 13, in the casing 11, a diameter D1 of the first component 20 is smaller than an inner diameter D2 of a portion where the grooved portion 11d is formed, and the first component 20 is centered at the center portion of the casing 11 by the two second components 50 attached at the outer side thereof. Therefore, the first component 20 can be withdrawn upward without interfering with the grooved portion 11d.

When the first component 20 is taken out from the casing 11, a bolt (not illustrated) is fixed to the longitudinal through hole 28 in the base 22 by a screw joint, and the bolt is pulled upward. In this process, the entirety of the core component including the second components 50 moves upward, and then, the second components 50 are hooked and stopped by the grooved portion 11d. When the bolt is further pulled upward in this state, the engagement protruding portion 52 of the second component 50 inserted into the guide groove 25 of the first component 20 comes off from the lower end opening of the guide groove 25, and thus only the first component 20 is slid upward and pulled out from the opening 11c.

According to the sensor unit 10 having the above-described configuration, the second components 50 provided on outer side of the core component contacts the inner circumferential surface of the casing 11 and a frictional force is generated, making it possible to sufficiently constrain the rotation and the positional deviation in the up-and-down direction of the core component which may occur during transport or rotation at the battery manufacturing facility. In addition, according to the sensor unit 10, even after the groove-forming in which the inner diameter of the casing 11 is reduced, the first component 20 to which the sensors are attached can be taken out from the casing 11 and easily retrieved. The second components 50 can be easily taken out by orienting the opening 11c of the casing 11 vertically downward after the first component 20 is taken out.

When a method of inspecting the battery manufacturing facility is performed using such a sensor unit 10, for example, the sensor unit 10 rotates the casing 11 at a high speed by a rotation roller that contacts an outer circumferential surface of the casing 11 in the groove-forming apparatus which is a part of the battery manufacturing facility. In the embodiment, in this process, using the sensor unit 10 makes it possible to visualize the force exerted on the exterior housing can from the battery manufacturing facility and to accurately and quickly specify the abnormal location in the facility.

The information detected by the sensors of the sensor unit 10 is acquired, and the state of the battery manufacturing facility is analyzed. As described above, on the casing 11 of the sensor unit 10, the grooved portion 11d is formed in a manner similar to that of the battery, and the first component 20 to which the sensors are attached is taken out from the casing 11 and retrieved after the formation of the grooved portion 11d. In this case, since it is possible to also visualize the force exerted on the exterior housing can during the groove-forming, the groove-forming apparatus can be inspected using the sensor unit 10.

The sensor unit 10 is introduced, for example, to the battery manufacturing facility at the timing of maintenance of the battery manufacturing facility, but may be alternatively introduced to the facility during production of the battery. The sensor unit 10 may be configured to be introduced to the facility periodically, such as once every day.

According to the facility inspection using the sensor unit 10, the abnormal location in the facility can be accurately and quickly specified, as described above. According to this method, for example, wear and damage of facility components, assembly deficiency of components, wear-out of the oil or core deviation of rotation components, and environment in the facility such as temperature, humidity, and atmospheric pressure can be easily visualized. In addition, when a plurality of manufacturing lines is provided in the manufacturing facility, process evaluation of the manufacturing apparatuses between the lines may be performed using the sensor unit 10.

Furthermore, the first component 20 that is a sensor attachment component can be held in the casing 11 by the second components 50 made of a resin that engage with the outer side of the first component 20 and that include the elastic portions 58 elastically pressed against the inner circumferential surface of the casing 11. This eliminates the need to place the O ring made of a rubber and having a large diameter to hold the first component 20 in the casing 11. Therefore, it is possible to prevent the eccentricity of the first component 20 in the casing 11 and to easily perform operation of inserting the first component 20 and the second components 50 into the casing 11, when the first component 20 and the second components 50 are inserted into the casing 11.

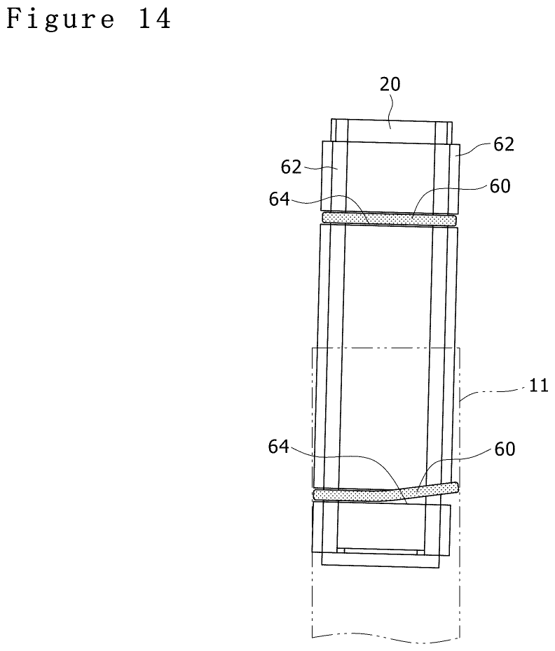

FIG. 14 illustrates a state in which a core component to which the O ring 60 is attached is in the process of being inserted into the casing 11, in the comparative example. In the comparative example, grooves 64 into which O rings 60 made of a rubber are fitted are provided at two positions in the axial direction of the second components 62 elongated in the axial direction, similarly to the configuration disclosed in Patent Literature 1. The first component 20 and the two second components 50 are integrated by the two O rings 60, and are inserted into the casing 11 in this state. At this time, friction between the O ring 60 and the casing 11 and friction between the O ring 60 and the core component cause pinching of the O rings 60 in a gap between the casing 11 and the core component. As illustrated in FIG. 14, the eccentricity of the core component may be caused in the casing 11. In this way, even when the core component is assembled to the casing as it is in a state in which the eccentricity of the core component is caused, the detection accuracy of the sensor may be decreased. According to the embodiment, since it is necessary to provide the O rings 60 as described above, the above-described eccentricity is not generated, and the core component is securely fixed to the casing 11, whereby the detection accuracy of the sensor can be improved.

The above-described embodiment can be suitably modified in design within a scope of not adversely affecting the advantage of the present disclosure. For example, in the above-described embodiment, a configuration is exemplified in which the two second components 50 are attached to the first component 20, but only one or three or more of second components may be attached to the first component. The outer walls having an arcuate shape in cross section of the second component may be provided only at one position in the axial direction or three or more positions in the axial direction. While a configuration in which two outer walls are provided on both sides in the circumferential direction in each second component has been described in the embodiment, only one outer wall in the circumferential direction may be provided.

### REFERENCE SIGNS LIST

10 Sensor unit, 11 Casing, 11a Side surface portion, 11b Bottom surface portion, 11c Opening, 11d Grooved portion, 20 First component, 21 Support assembly, 22 Base, 23 Side surface portion, 24 Bottom surface portion, 25, 26 Guide groove, 27 Transverse through hole, 28 Longitudinal through hole, 29a, 29b Lead fixation portion, 29c Thread hole, 30 First substrate, 31 Microcomputer module, 32 Acceleration sensor, 33 Gyro sensor, 34 Environment sensor, 35 Memory, 36 First cover, 36a, 46a, 52 Protruding portion, 36b Opening, 37 Screw, 40 Second substrate, 41 Connection terminal, 45 Battery, 46 Second cover, 50 Second component, 51 Inner wall, 52 Engagement protruding portion, 55 Outer wall, 56 Cavity portion, 58 Elastic portion, 60 O ring, 62 Second component, 64 Groove

1. A sensor unit to be introduced to a battery manufacturing facility, the sensor unit comprising:
a bottomed cylindrical casing that is processed in a manner similar to a manner of an exterior housing can of a battery by the battery manufacturing facility;
a sensor that detects a force acting on the casing from the battery manufacturing facility;
a pillar-shaped first component to which the sensor is attached and that is housed inside the casing; and
at least one second component made of a resin that is placed at an outer side of the first component to engage with the first component,
wherein the second component includes an elastic portion that is elastically pressed against an inner circumferential surface of the casing and a cavity portion that is formed inside the elastic portion.

2. The sensor unit according to claim 1, wherein
the at least one second component comprises a plurality of second components attached at a plurality of positions in a circumferential direction of an outer circumferential surface of the first component,
each of the plurality of second components includes an inner wall facing an outer circumferential surface of the first component, and an outer wall facing an inner circumferential surface of the casing,
both ends of the outer wall in an axial direction of the casing are connected to the inner wall,
the elastic portion is formed to project in an arcuate manner toward the casing in a cross section in which at least a part of the outer wall is along an axial direction, and
the cavity portion is formed between the elastic portion and the inner wall.

3. The sensor unit according to claim 2, wherein
in each of the plurality of second components, the elastic portions are formed at a plurality of positions in the axial direction of the outer wall.

4. The sensor unit according to claim 1, wherein
in the casing, a grooved portion is formed near an opening by the battery manufacturing facility in a manner similar to a manner of the exterior housing can,
the first component is placed in a manner such that a maximum outer diameter portion thereof does not overlap with the grooved portion in the axial direction of the casing, and
the second component is placed in a manner such that a maximum outer diameter portion thereof does overlap with the grooved portion in the axial direction of the casing.

5. The sensor unit according to claim 4, wherein
the second component includes an engagement protruding portion that protrudes from the inner wall to the first component,
in the first component, a guide groove into which the engagement protruding portion is fitted and that extends in the axial direction of the casing is formed, and the first component is configured to be slid along the guide groove to be able to be separated from the second component.
